(19) United States
(12) Patent Application Publication
(10) Pub. No.: US 2026/0128504 A1
(43) Pub. Date: May 7, 2026

(54) ELECTRONIC DEVICES

(71) Applicant: SHENZHEN SHOKZ CO., LTD., Shenzhen (CN)

(72) Inventors: Shuailin XIE, Shenzhen (CN); Chunjian LIU, Shenzhen (CN)

(73) Assignee: SHENZHEN SHOKZ CO., LTD., Shenzhen (CN)

(21) Appl. No.: 19/435,699

(22) Filed: Dec. 29, 2025

Related U.S. Application Data
(63) Continuation of application No. PCT/CN2023/126020, filed on Oct. 23, 2023.

(51) Int. Cl. H01Q 1/27; H01Q 1/48; H04R 1/02; H04R 1/10; H04R 3/00

(52) U.S. Cl. CPC H01Q 1/273; H01Q 1/48; H04R 1/02; H04R 1/10; H04R 3/00

(57) ABSTRACT

An earphone (100) comprising a case, a circuit board, and an antenna assembly is provided. The case includes a plastic substrate and reinforcing fibers mixed in the plastic substrate. The circuit board is installed in the case. The antenna assembly is mounted on a sidewall of the case and includes an antenna bracket and a Laser Direct Structuring (LDS) antenna pattern formed on the antenna bracket. The LDS antenna pattern is electrically connected to the circuit board.

### CROSS-REFERENCE RELATED TO APPLICATIONS

The present disclosure is a continuation of International Application NO. PCT/CN2023/126020, filed on Oct. 23, 2023, the entire contents of which are hereby incorporated by reference.

### TECHNICAL FIELD

The present disclosure belongs to the technical field of electronic devices, and specifically relates to earphones.

### BACKGROUND

With the continuous proliferation of electronic devices, they have become indispensable tools for social interaction and entertainment in people's daily lives. Consequently, user expectations for the performance and functionality of such devices are increasingly high.

Devices such as earphones and smart glasses are now widely integrated into everyday life, often used in conjunction with terminals such as a smartphone, a computer, etc., to provide users with an immersive auditory experience.

However, current earphones face issues related to their relatively large size and inefficient utilisation of internal space.

### SUMMARY

The present disclosure provides an earphone comprising a case, a circuit board, and an antenna assembly. The case includes a plastic substrate and reinforcing fibers mixed in the plastic substrate. The circuit board is installed in the case. The antenna assembly is mounted on a sidewall of the case and includes an antenna bracket and a Laser Direct Structuring (LDS) antenna pattern formed on the antenna bracket. The LDS antenna pattern is electrically connected to the circuit board.

In some embodiments, the sidewall includes two main sidewall portions spaced apart from each other and two auxiliary sidewall portions connecting the two main sidewall portions and spaced apart from each other. An area of each of the main sidewall portions is larger than an area of each of the auxiliary sidewall portions. A main surface of the circuit board faces the main sidewall portions, the antenna bracket is arranged on the main sidewall portions, and the LDS antenna pattern is formed on a side of the antenna bracket.

Through the above configuration, the antenna bracket can be fabricated using LDS plastic, which is then mounted onto the case. On one hand, this configuration reduces the volume of the antenna assembly, facilitates the design of a clearance zone, and improves space utilisation inside the case of the earphone. On the other hand, since the material of the case is different from the material of the antenna bracket, constraints on material selection for the case can be reduced, thus increasing the diversity of available material options.

In some embodiments, one of the main sidewall portions is provided with an accommodation groove, and the antenna bracket is accommodated in the accommodation groove.

In some embodiments, the thickness of the antenna bracket is less than or equal to the depth of the accommodation groove.

In some embodiments, a surface on which the LDS antenna pattern is located faces the circuit board, and the antenna assembly further includes a feeding portion and a grounding portion electrically connected to the LDS antenna pattern. The feeding portion and the grounding portion are arranged on a side of the LDS antenna pattern facing the circuit board and protrude beyond the circuit board.

In some embodiments, the accommodation groove is located on an inner surface of the main sidewall portion, and the LDS antenna pattern is entirely located on a side of an opening of the accommodation groove away from the circuit board.

In some embodiments, a surface on which the LDS antenna pattern is located faces away from the circuit board. The antenna assembly further includes a feeding portion and a grounding portion electrically connected to the LDS antenna pattern. The feeding portion and the grounding portion penetrate through the antenna bracket and are exposed from a surface opposite to the surface on which the LDS antenna pattern is located.

In some embodiments, the accommodation groove is located on an outer surface of the main sidewall portion, and the LDS antenna pattern is entirely located on a side of an opening of the accommodation groove facing the circuit board. The case further includes an elastic coating covering the outer surface of the main sidewall portion on which the accommodation groove is located and an outer side of the antenna assembly.

In some embodiments, the accommodation groove is located on an outer surface of the main sidewall portion. The main sidewall portion is provided with a first through hole and a second through hole located in the accommodation groove. The earphone further comprises a first electrical connector and a second electrical connector. The first electrical connector electrically connects the circuit board to the feeding portion via the first through hole, and the second electrical connector electrically connects the circuit board to the grounding portion via the second through hole.

In some embodiments, the first electrical connector and the second electrical connector are respectively inserted into the first through hole and the second through hole, or, the first through hole and the second through hole are respectively provided with a first adapter portion and a second adapter portion, wherein the first adapter portion connects the first electrical connector to the feeding portion, and the second adapter portion connects the second electrical connector to the grounding portion.

In some embodiments, in a wearing state, the main sidewall portion where the antenna bracket is located is positioned on a side of the case away from the skin of a user.

In some embodiments, a content of the reinforcing fibers in the case is greater than 30%.

### BRIEF DESCRIPTION OF THE DRAWINGS

To provide a clearer explanation of the technical solutions in the embodiments of the present disclosure, the following sections will briefly introduce the drawings required for describing the embodiments. It is obvious that the drawings in the following description represent only some embodiments of the present disclosure. Those of ordinary skill in the art may obtain other drawings based on these provided drawings without exerting inventive efforts.

FIG. 1 is a schematic diagram illustrating an overall structure of an earphone according to some embodiments of the present disclosure.

FIG. 2 is a schematic diagram illustrating an exemplary core assembly of the earphone according to some embodiments of the present disclosure.

FIG. 3 is a schematic diagram illustrating an internal structure of a case of the earphone according to some embodiments of the present disclosure.

FIG. 4 is a schematic diagram illustrating an LDS antenna pattern of the earphone according to some embodiments of the present disclosure.

FIG. 5 is a schematic cross-sectional view illustrating an antenna assembly of the earphone according to some embodiments of the present disclosure.

FIG. 6 is a schematic cross-sectional view illustrating an exemplary internal structure of a case of the earphone according to some embodiments of the present disclosure.

FIG. 7 is a schematic cross-sectional view illustrating another exemplary internal structure of a case of the earphone according to some embodiments of the present disclosure.

### DETAILED DESCRIPTION

The present disclosure will be further described in detail below with reference to the accompanying drawings and embodiments. It should be noted that the following embodiments are merely intended to illustrate the present disclosure but not to limit its scope. Likewise, the following embodiments are only part of the embodiments of the present disclosure and not exhaustive thereof. All other embodiments obtained by a person of ordinary skill in the art without creative efforts shall fall within the scope of protection of the present disclosure.

The terms such as “an embodiment,” “one embodiment,” and “some embodiments” in present disclosure imply that the specific features, structures, or characteristics described in connection with the embodiments may be included in at least one embodiment of the present disclosure. Those skilled in the art may understand, both explicitly and implicitly, that the embodiments described herein may be combined with other embodiments.

An antenna is a commonly used component for transmitting and receiving an electromagnetic wave. Since a conductive metal may reflect, absorb, or cancel the electromagnetic wave, the electromagnetic wave is easily affected by metal. Therefore, the antenna often needs to be positioned away from metal components during the design process to reserve a clearance zone and enhance communication performance.

The inventors of the present disclosure have found through research that in existing earphone designs, a Planar Inverted-F Antenna (PIFA) is commonly used. However, the PIFA generally occupies a relatively large volume, thereby reducing the internal space utilisation of a housing of the earphone. In contrast, if an antenna fabricated using Laser Direct Structuring (LDS) technology (also referred to as an LDS antenna) is applied to an electronic device such as a mobile phone and an earphone, a significant design space can be saved, thus reducing the overall size of the electronic device and increasing the clearance zone. However, the housing portion of conventional earphones often cannot be used to form the LDS antenna via the LDS technology.

The fabricating an antenna using the LDS technology generally includes the following operations. First, a housing is made from LDS plastic, a modified plastic material containing organometallic compounds. The organometallic compounds release metal particles when irradiated by a laser. The surface of the housing is then exposed to laser radiation to form a seed layer, which is formed by metal particles released from the LDS plastic under the irradiation of the laser. By controlling the path of the laser, the seed layer with a predefined pattern is created. Finally, the surface of the seed layer with the predefined pattern is metallized through a chemical electroless plating process, so that a metal layer with a thickness of several micrometers grows on the surface of the seed layer, resulting in the formation of the LDS antenna.

As described above, the preparation of an LDS antenna requires LDS plastic as a base material. The LDS plastic generally has the following properties: (i) electrical insulation; (ii) non-catalytic activity; (iii) resistance to visible light; (iv) uniform dispersibility in a plastic matrix; (v) capability of releasing metal particles upon laser irradiation; (vi) high-temperature resistance and chemical corrosion resistance; (vii) low toxicity; and (viii) non-volatility, non-migration, and good resistance to extraction. Common LDS plastics can be prepared from materials such as: Polyamide 4T (PA4T, a high-temperature-resistant polyamide), Liquid Crystal Polymer (LCP), Polycarbonate/Acrylonitrile Butadiene Styrene alloy (PC/ABS, an engineering plastic alloy), Polyhexamethylene adipamide (PA46, also known as polyamide 46 or nylon 46), Polyphthalamide (PPA), Polypropylene (PP), High-Temperature Nylon (HTN, a heat-resistant polyamide), Polyamide (PA, polyamide resin), Polyphenylene ether (PPO), Polyether ether ketone (PEEK), or the like.

The following embodiments of the present disclosure describe exemplary structures of an earphone.

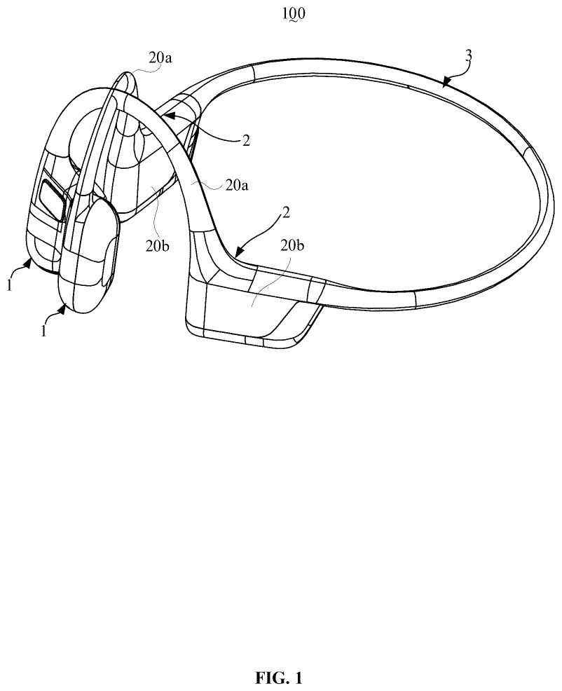

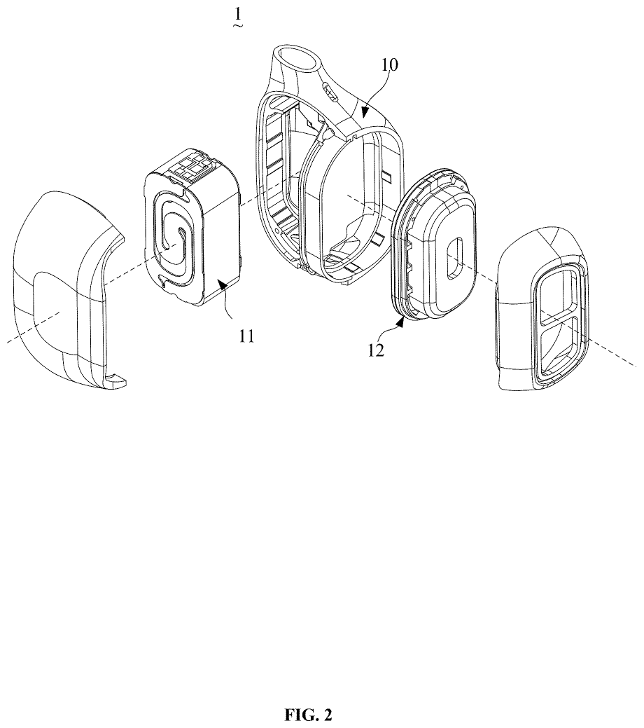

Referring to FIGS. 1, 2, and 3, earphones 100 may include one or more core assemblies 1, one or more ear-hook assemblies 2, and a rear-hook assembly 3.

The count of core assemblies 1 may be two. Each of the two core assemblies 1 is configured to transmit a vibration and/or a sound to a user. A core assembly 1 may include a housing assembly 10, a bone conduction speaker 11, and an air conduction speaker 12. The bone conduction speaker 11 and the air conduction speaker 12 may be arranged within the housing assembly 10. The air conduction speaker 12 transmits the sound to an ear canal of the user via air vibration, and the bone conduction speaker 11 transmits the sound to the user through bone conduction vibration. The two core assemblies 1 may be identical or different. For example, one core assembly 1 may be provided with a microphone, while the other core assembly 1 may not be provided with a microphone. As another example, one core assembly 1 may include one or more buttons and a corresponding circuit board, and the other core assembly 1 may not be provided with one or more buttons and a corresponding circuit board. Core modules (e.g., speaker modules) of the two core assemblies 1 may be the same. In the following descriptions, the core assembly 1 described may be understood as being described in detail with reference to one of the two core assemblies 1.

The count of ear-hook assemblies 2 may also be two. The two ear-hook assemblies 2 may be worn on the left ear and the right ear of the user, enabling the core assemblies 1 to fit against the user's face. One end of each ear-hook assembly 2 is connected to a core assembly 1, and the other end of each ear-hook assembly 2 is connected to the rear-hook assembly 3. Each of the two ear-hook assemblies 2 may include an ear hook 20a for engaging the user's ear and a case assembly 20b for accommodating at least one of a battery, a circuit board, or an antenna assembly. The case assembly 20b may be separate from and detachably connected to the ear hook 20a. Furthermore, the two ear-hook assemblies 2 may be identical or partially different.

For example, one case assembly 20b may be provided with the battery, and the other case assembly 20b may be provided with the circuit board, the antenna assembly, etc. The circuit board may be electrically connected to at least one of the battery, the bone conduction speaker, the air conduction speaker, the microphone, or the antenna assembly.

The rear-hook assembly 3 connects the two ear-hook assemblies 2 and is configured to wrap around the back side of the neck or the head of the user. The rear-hook assembly 3 provides a clamping force to securely press the two core assemblies 1 against two sides of the user's face and stabilize the ear-hook assemblies 2 on the user's ears. Alternatively, the earphone 100 may not include the rear-hook assembly 3, in which case a core assembly 1 is worn on the user's ears solely via an ear-hook assembly 2.

In some embodiments of the present disclosure, the material of the housing assembly 10 may include, but is not limited to, a mixture of materials such as polycarbonate, polyamide, or acrylonitrile butadiene styrene (ABS) copolymer with glass fiber or carbon fiber. In some embodiments, the material of the housing assembly 10 may be a blend of carbon fiber and polycarbonate in a predetermined ratio, or a blend of glass fiber and polycarbonate in a predetermined ratio, or a blend of glass fiber and polyamide in a predetermined ratio. In other embodiments, the material of the housing assembly 10 may include a blend of carbon fiber, glass fiber, and polycarbonate in a predetermined ratio. By varying the proportions of carbon fiber and/or glass fiber, the hardness of the material can be adjusted, resulting in the housing assembly 10 with different levels of stiffness.

In some embodiments, the case assembly 20b of the ear-hook assembly 2 may need to balance strength and weight. For example, the housing portion (i.e., a case) of the case assembly 20b must have a relatively low weight while maintaining sufficient strength. Therefore, the case of the ear-hook assembly 2 is often made from a reinforcing material containing glass fiber.

However, if the case is further modified with organometallic compounds for LDS antenna fabrication, the case tends to become more brittle and exhibit reduced toughness. As a result, the case of the ear-hook assembly 2 is generally unsuitable for forming the LDS antenna.

The following describes an exemplary structure of the ear-hook assembly 2 according to some embodiments of the present disclosure.

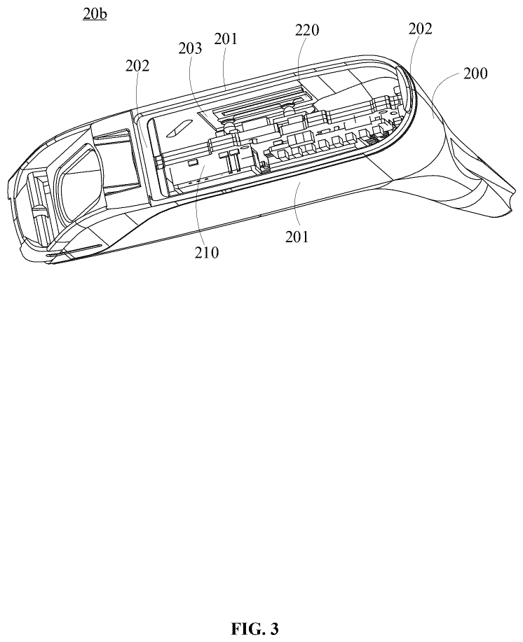

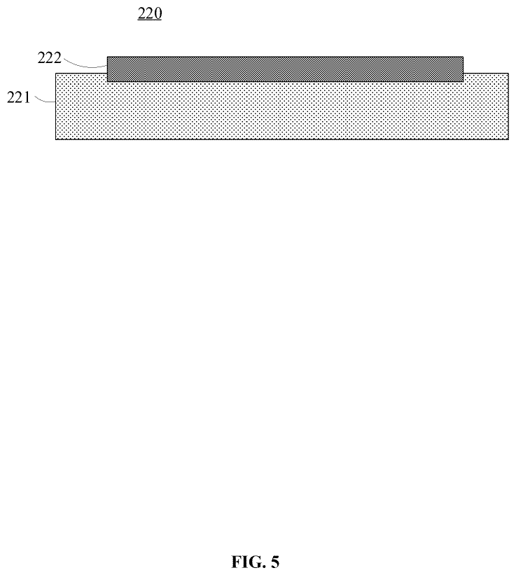

As mentioned above and with reference to FIGS. 3, 4, and 5, the case assembly 20b of one of the two ear-hook assemblies 2 may include a case 200, a circuit board 210, and an antenna assembly 220. The case 200 includes a plastic substrate and reinforcing fiber mixed in the plastic substrate. The circuit board 210 is arranged in the case 200. The antenna assembly 220 is arranged on a sidewall of the case 200 and includes an antenna bracket 221 and an LDS antenna pattern 222 formed on the antenna bracket 221. The LDS antenna pattern 222 is electrically connected to the circuit board 210.

Through the above-described approach, the antenna bracket 221 may be fabricated using LDS plastic and then mounted onto the case 200. On one hand, this arrangement reduces the volume of the antenna assembly 220, facilitates the design of the clearance zone, and improves the space utilisation inside the case 200 of the ear-hook assembly 2. On the other hand, this arrangement allows the material of the case 200 to differ from that of the antenna bracket 221, thereby reducing constraints on material selection for the case 200 and increasing the diversity of available material options.

In some embodiments, the plastic substrate may include a plastic material such as polycarbonate, polyamide, acrylonitrile butadiene styrene (ABS) copolymer, or the like. In some embodiments, the content of the reinforcing fibers in the case 200 exceeds 30%. For example, the content of the reinforcing fibers may be 30%, 40%, 45%, 50%, 60%, etc. As another example, the content of the reinforcing fibers may range from 45% to 60%. The reinforcing fibers may be carbon fibers, glass fibers, or the like.

In some embodiments, the sidewall of the case 200 includes two main sidewall portions 201 spaced apart from each other, and two auxiliary sidewall portions 202 connecting the two main sidewall portions 201 and spaced apart from each other. The two main sidewall portions 201 may be substantially parallel plate-like structures, and the two auxiliary sidewall portions 202 may be curved to ensure a smooth transition between the two main sidewall portions 201 via the auxiliary sidewall portions 202.

In some embodiments, the area of each of the main sidewall portions 201 is greater than the area of each of the auxiliary sidewall portions 202, and the main surface of a circuit board 210 faces one of the main sidewall portions 201. The main surface of the circuit board 210 refers to a surface where circuit structures are provided. In some embodiments, a light guide portion (not shown in the drawings) may be provided on one of the two main sidewall portions 201 of the case 200, and one main surface of the circuit board 210 is arranged facing the light guide portion. An indicator light (not shown in the drawings) may be provided on the main surface facing the light guide portion. Light emitted from the indicator light may pass through the light guide component and exit to the exterior of the earphone 100. In some embodiments, the light guide portion may be a lampshade.

The antenna bracket 221 is arranged on one of the two main sidewall portions 201, and the LDS antenna pattern 222 is formed on one side of the antenna bracket 221. For example, the antenna bracket 221 may be attached to the main sidewall portion 201, and the LDS antenna pattern 222 may be formed on a side surface of the antenna bracket 221 away from the main sidewall portion 201. By configuring the circuit board 210 and the antenna assembly 220 in the above manner, the volume of the case 200 can be reduced while providing protection for the antenna assembly 220.

In some embodiments, the antenna bracket 221 is plate-shaped. For example, the antenna bracket 221 may be a flat plate structure or a plate structure having a bent portion. The antenna bracket 221 has two opposite plate surfaces, and a direction from one plate surface to the other plate surface defines a thickness direction of the antenna bracket 221. One plate surface of the antenna bracket 221 may be attached to one of the two main sidewall portions 201, and the LDS antenna pattern 222 is provided on the opposite plate surface. The LDS antenna pattern 222 is directly formed on the antenna bracket 221 through LDS technology. The antenna bracket 221 may be mounted on the main sidewall portion 201 through bonding, etc.

In some embodiments, in a wearing state, the main sidewall portion 201 where the antenna bracket 221 is located is positioned on a side of the case 200 facing away from the skin of the user. With this arrangement, the influence of an electromagnetic wave emitted by the antenna assembly on the user can be reduced, and the antenna assembly 220 can more effectively transmit and receive the electromagnetic wave. The main sidewall portion 201 where the antenna bracket 221 is located may also be the main sidewall portion 201 provided with the light guide portion.

In some embodiments, one of the two main sidewall portions 201 is provided with an accommodation groove 203, and the antenna bracket 221 is accommodated in the accommodation groove 203. With this arrangement, the distance between the antenna assembly 220 and the circuit board 210 can be further increased, thereby enlarging the clearance zone or improving the space utilisation inside the case 200.

In some embodiments, the thickness of the antenna bracket 221 is less than or equal to the depth of the accommodation groove 203. With this arrangement, the entire antenna assembly 220 can be accommodated in the accommodation groove 203 without protruding beyond an opening of the accommodation groove 203, further increasing the distance between the antenna assembly 220 and the circuit board 210, thereby enlarging the clearance zone or improving the space utilisation inside the case 200.

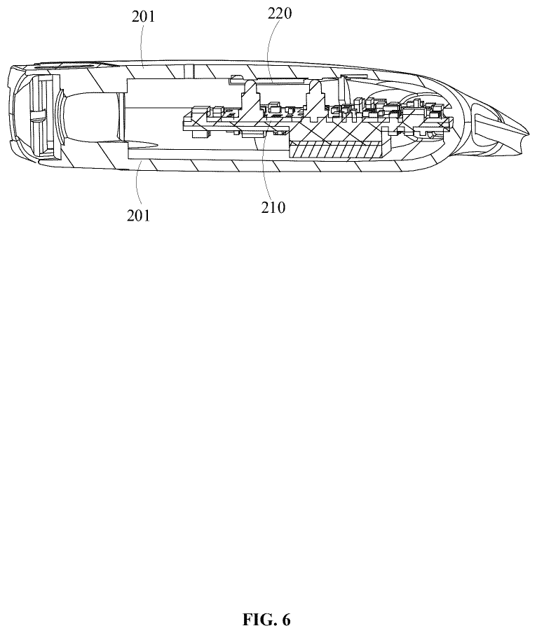

Referring to FIGS. 3 and 6, in some embodiments, the accommodation groove 203 may be located on the inner surface of the main sidewall portion 201, and the LDS antenna pattern 222 is entirely located on a side of an opening of the accommodation groove 203 facing away from the circuit board 210. With this arrangement, the antenna assembly 220 can be entirely housed inside the case 200, and the LDS antenna pattern 222 may be substantially flush with the inner surface of the main sidewall portion 201, or the LDS antenna pattern 222 may be positioned further away from the circuit board 210 with respect to the opening of the accommodation groove 203 or the inner surface of the main sidewall portion 201. This arrangement not only protects the antenna assembly 220 but also further increases the distance between the antenna assembly 220 and the circuit board 210, thereby enlarging the clearance zone.

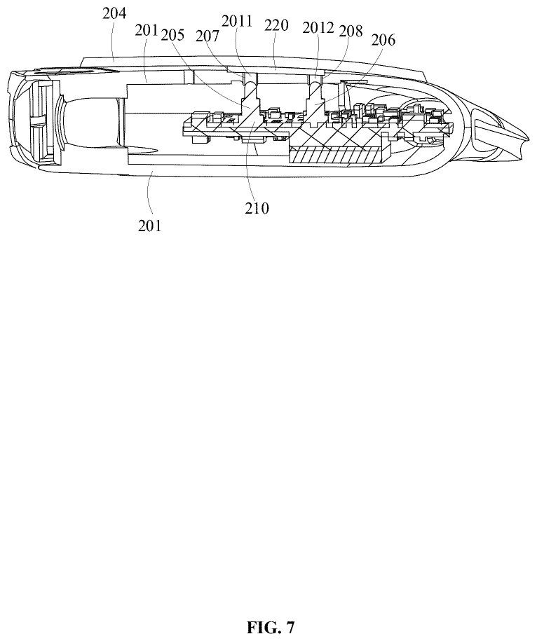

Referring to FIG. 7, in some embodiments, the accommodation groove 203 may be located on an outer surface of the main sidewall portion 201, and the LDS antenna pattern 222 is entirely located on a side of an opening of the accommodation groove 203 facing toward the circuit board 210. Thus, the LDS antenna pattern 222 can be accommodated within the accommodation groove 203 without protruding beyond the outer surface of the main sidewall portion 201 (i.e., the LDS antenna pattern 222 is flush with the outer surface of the main sidewall portion 201, or the LDS antenna pattern 222 is positioned closer to the circuit board 210 relative to the outer surface of the main sidewall portion 201), which is advantageous for improving the wearing experience of the user.

In some embodiments, the case 200 further includes an elastic coating layer 204 covering an outer surface of the main sidewall portion 201 on which the accommodation groove 203 is located the and an outer side of the antenna assembly 220. By providing the elastic coating layer 204, the antenna assembly 220 can be isolated from the external environment. In addition, the elastic coating layer 204 conforms better to the user's head or face, thereby further improving the comfort during wear.

Referring again to FIGS. 3 to 6, in some embodiments, the plate surface on which the LDS antenna pattern 222 is located faces toward the circuit board 210. The antenna assembly 220 further includes a feed portion 223 and a grounding portion 224, both electrically connected to the LDS antenna pattern 222. The feed portion 223 and the grounding portion 224 are arranged on a side of the LDS antenna pattern 222 facing toward the circuit board 210 and protrude beyond the circuit board 210. This arrangement facilitates the assembly of the antenna assembly 220 and the circuit board 210. The feed portion 223 and the grounding portion 224 may abut against the circuit board 210 through a metal elastic member (not shown in the drawings), thereby realizing an electrical connection between the antenna assembly 220 and the circuit board 210. The metal elastic member may be an elastic pin (e.g., a pogo pin) or a metal elastic sheet. The metal elastic member is elastically retractable, thereby reducing the risk of electrical disconnection between the antenna assembly 220 and the circuit board 210 during movement. The metal elastic member may be fixed on the circuit board 210.

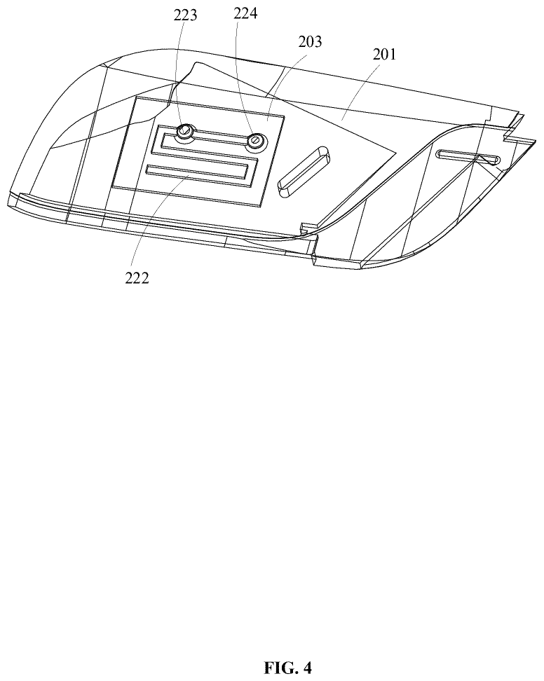

Referring to FIG. 7, in some embodiments, the surface on which the LDS antenna pattern 222 is located faces away from the circuit board 210. Referring to FIG. 4, the antenna assembly 220 further includes a feed portion 223 and a grounding portion 224 electrically connected to the LDS antenna pattern 222. The feed portion 223 and the grounding portion 224 extend through the antenna bracket 221 and are exposed from a surface opposite to the surface on which the LDS antenna pattern 222 is located. With this arrangement, the distance between the LDS antenna pattern 222 and the circuit board 210 can be further increased, or the space utilisation inside the case 200 can be further improved.

Referring to FIG. 7, the accommodation groove 203 may be located on an outer surface of the main sidewall portion 201, a first through hole 2011 and a second through hole 2012 are provided on the main sidewall portion 201 on which the accommodation groove 203 is located, and the first through hole 2011 and the second through hole 2012 are located within the accommodation groove 203. The ear-hook assembly 2 of the earphone 100 further includes a first electrical connector 205 and a second electrical connector 206. The first electrical connector 205 electrically connects the circuit board 210 and the feed portion 223 through the first through hole 2011, and the second electrical connector 206 electrically connects the circuit board 210 and the grounding portion 224 through the second through hole 2012. The arrangement of the first through hole 2011 and the second through hole 2012 provides a guiding function for the first electrical connector 205 and the second electrical connector 206, thereby enhancing the reliability of the electrical connection between the first electrical connector 205 and the feeding portion 223, and the electrical connection between the second electrical connector 206 and the grounding portion 224.

In some embodiments, the first electrical connector 205 and the second electrical connector 206 are respectively inserted into the first through hole 2011 and the second through hole 2012. The first electrical connector 205 and the second electrical connector 206 may be elastic pins (pogo pins). The first electrical connector 205 and the second electrical connector 206 are elastically retractable, thereby reducing the risk of electrical disconnection between the antenna assembly 220 and the circuit board 210 during movement.

In some embodiments, the first through hole 2011 and the second through hole 2012 may be conductive through holes. For example, referring to FIGS. 7 and 4, the first through hole 2011 and the second through hole 2012 are respectively provided with a first adapter portion 207 and a second adapter portion 208. The first adapter portion 207 connects the first electrical connector 205 and the feed portion 223, and the second adapter portion 208 connects the second electrical connector 206 to the grounding portion 224. This arrangement reduces the difficulty in disassembling and assembling the antenna assembly 220. Through this arrangement, the electrical connection between the feed portion 223 and the first electrical connector 205, as well as the electrical connection between the grounding portion 224 and the second electrical connector 206, can be made more reliable. The first adapter portion 207 and the second adapter portion 208 may also be conductive metal coatings applied or plated on inner surfaces of the first through hole 2011 and the second through hole 2012, respectively. For example, the first adapter portion 207 and the second adapter portion 208 may be copper layers electroplated or chemically plated on the first through hole 2011 and the second through hole 2012.

In summary, embodiments of the present disclosure provide an earphone 100. The ear-hook assembly 2 of the earphone 100 includes an ear hook 20a and a case assembly 20b. The case body assembly 20b includes a case 200, a circuit board 210, and an antenna assembly 220. The case 200 includes a plastic substrate and reinforcing fibers mixed in the plastic substrate.

The circuit board 210 is arranged in the case 200. The antenna assembly 220 is mounted on a sidewall of the case 200 and includes an antenna bracket 221 and an LDS antenna pattern 222 formed on the antenna bracket 221. The LDS antenna pattern 222 is electrically connected to the circuit board 210.

In the above manner, the antenna bracket 221 can be fabricated using LDS plastic, and the antenna bracket 221 can then be mounted on the case 200. On one hand, this arrangement reduces the volume of the antenna assembly 220, facilitates the design of the clearance zone, and improves the space utilisation inside the case 200 of the ear-hook assembly 2. On the other hand, this arrangement allows the material of the case 200 to differ from that of the antenna bracket 221, thereby reducing constraints on material selection for the case 200 and increasing the diversity of available material options. The foregoing descriptions relate only to some embodiments of the present disclosure and are not intended to limit the scope of protection of the present disclosure. Any equivalent device or equivalent process transformation made based on the contents of the descriptions and drawings of the present disclosure, or any direct or indirect application in other related technical fields, shall also fall within the scope of protection of the present disclosure.

What is claimed is:

1. An earphone comprising
a case including a plastic substrate and reinforcing fibers mixed in the plastic substrate;
a circuit board installed in the case; and
an antenna assembly mounted on a sidewall of the case and including an antenna bracket (221) and a Laser Direct Structuring (LDS) antenna pattern formed on the antenna bracket (221), wherein the LDS antenna pattern is electrically connected to the circuit board.

2. The earphone of claim 1, wherein the sidewall includes two main sidewall portions spaced apart from each other, and two auxiliary sidewall portions connecting the two main sidewall portions and spaced apart from each other,
a main surface of the circuit board faces one of the two main sidewall portions, the antenna bracket is arranged on one of the two main sidewall portions, and the LDS antenna pattern is formed on a side of the antenna bracket.

3. The earphone of claim 2, wherein one of the main sidewall portions is provided with an accommodation groove, and the antenna bracket is accommodated in the accommodation groove.

4. The earphone of claim 3, wherein a thickness of the antenna bracket is less than or equal to a depth of the accommodation groove.

5. The earphone of claim 3, wherein a surface on which the LDS antenna pattern is located faces the circuit board, and the antenna assembly further includes a feeding portion and a grounding portion electrically connected to the LDS antenna pattern, wherein the feeding portion and the grounding portion are arranged on a side of the LDS antenna pattern facing the circuit board and protrude beyond the circuit board.

6. The earphone of claim 5, wherein the accommodation groove is located on an inner surface of the one of the two main sidewall portions, and the LDS antenna pattern is entirely located on a side of an opening of the accommodation groove away from the circuit board.

7. The earphone of claim 3, wherein a surface on which the LDS antenna pattern is located faces away from the circuit board, and the antenna assembly further includes a feeding portion and a grounding portion electrically connected to the LDS antenna pattern, wherein the feeding portion and the grounding portion penetrate through the antenna bracket and are exposed from a surface opposite to the surface on which the LDS antenna pattern is located.

8. The earphone of claim 7, wherein the accommodation groove is located on an outer surface of the one of the two main sidewall portions, the LDS antenna pattern is entirely located on a side of an opening of the accommodation groove facing the circuit board.

9. The earphone of claim 5, wherein the accommodation groove is located on an outer surface of the one of the two main sidewall portions, the main sidewall portion on which the accommodation groove is located is provided with a first through hole and a second through hole, the first through hole and the second through hole being located in the accommodation groove, and the earphone further comprises a first electrical connector and a second electrical connector, wherein the first electrical connector electrically connects the circuit board to the feeding portion via the first through hole, and the second electrical connector electrically connects the circuit board to the grounding portion via the second through hole.

10. The earphone of claim 9, wherein the first electrical connector and the second electrical connector are respectively inserted into the first through hole and the second through hole.

11. The earphone of claim 9, wherein the first through hole and the second through hole are respectively provided with a first adapter portion and a second adapter portion, wherein the first adapter portion connects the first electrical connector to the feeding portion, and the second adapter portion connects the second electrical connector to the grounding portion.

12. The earphone of claim 2, wherein, in a wearing state, the main sidewall portion where the antenna bracket is located is positioned on a side of the case away from the skin of a user.

13. The earphone of claim 1, wherein a content of the reinforcing fibers in the case is greater than 30%.

14. The earphone of claim 1, wherein the antenna assembly further includes a feeding portion and a grounding portion electrically connected to the LDS antenna pattern.

15. The earphone of claim 14, wherein the feed portion and the grounding portion are arranged on a side of the LDS antenna pattern facing toward the circuit board and protruding beyond the circuit board.

16. The earphone of claim 14, wherein the feed portion and the grounding portion extend through the antenna bracket and are exposed from a surface opposite to the surface on which the LDS antenna pattern is located.

17. The earphone of claim 2, wherein the two auxiliary sidewall portions are curved to ensure a transition between the two main sidewall portions via the auxiliary sidewall portions.

18. The earphone of claim 2, wherein an area of each of the main sidewall portions is larger than an area of each of the auxiliary sidewall portions.

19. The earphone of claim 1, wherein the antenna bracket has two opposite plate surfaces, one plate surface of the antenna bracket is attached to one of the two main sidewall portions, and the LDS antenna pattern is provided on the opposite plate surface.

20. The earphone of claim 8, wherein the case further includes an elastic coating covering the outer surface of the main sidewall portion on which the accommodation groove is located and an outer side of the antenna assembly.
